(19) United States
(12) Patent Application Publication
(10) Pub. No.: US 2025/0320086 A1
(43) Pub. Date: Oct. 16, 2025

(54) PERFORMANCE OF AN ELEVATOR ASSOCIATED ACTION

(71) Applicant: KONE Corporation, Helsinki (FI)

(72) Inventor: Mari ZAKRZEWSKI, Helsinki (FI)

(73) Assignee: KONE Corporation, Helsinki (FI)

(21) Appl. No.: 19/248,679

(22) Filed: Jun. 25, 2025

Related U.S. Application Data
(63) Continuation of application No. PCT/EP2023/055314, filed on Mar. 2, 2023.

(51) Int. Cl. B66B 5/00

(52) U.S. Cl. CPC B66B 5/0012; B66B 5/0031

(57) ABSTRACT

According to an aspect, there is provided a solution in which sensor data may be obtained from at least one radar sensor arranged in an elevator car. Micro-Doppler signatures of at least one moving object associated with the elevator car may be determined based on the sensor data and the at least one moving object associated with the elevator car may be classified into at least one type based on their micro-Doppler signatures. An elevator associated action may then be performed based on the classifying.

### TECHNICAL FIELD

Various example embodiments generally relate to the field of elevator systems. In particular, some example embodiments relate to a solution for performing an elevator associated action based on at least one moving object associated with an elevator car.

### BACKGROUND

One or more sensors may be arranged inside an elevator car to sense objects in the elevator car. For example, a camera may be arranged in a ceiling of the elevator car to provide a wide angle view of the room inside the elevator car. The image provided by the camera may then be analyzed, for example, to provide information on the number of passengers in the elevator car. By adding further sensors, they may be used for sensing some other characteristics of the interior of the elevator. The use of different types of sensors for different purposes makes the overall elevator car sensor solution complicated and expensive.

### SUMMARY

According to a first aspect, there is provided a method that comprises obtaining sensor data from at least one radar sensor arranged in an elevator car; analyzing the sensor data to provide micro-Doppler signatures of at least one moving object associated with the elevator car in a direction towards the at least one radar sensor and/or away from the at least one radar sensor; classifying the at least one moving object associated with the elevator car into at least one type based on their micro-Doppler signatures; and performing an elevator associated action based on the classifying.

In an implementation form of the first aspect, performing an elevator associated action based on the classifying comprises detecting an entrapment situation in the elevator car, and triggering an alert in response to detecting the entrapment situation in the elevator car.

In an implementation form of the first aspect, the method further comprises determining the entrapment situation by detecting at least one person inside the elevator car and detecting that the elevator doors are closed.

In an implementation form of the first aspect, performing an elevator associated action based on the classifying comprises detecting a prohibited object in the elevator car, and stopping the elevator car in response to detecting the prohibited object in the elevator car.

In an implementation form of the first aspect, performing an elevator associated action based on the classifying comprises determining the number of passengers in the elevator car based on the micro-Doppler signatures.

In an implementation form of the first aspect, performing an elevator associated action based on the classifying comprises detecting at least one predetermined object entering the elevator car, and adjusting door closing times of the elevator in response to detecting the least one predetermined object entering the elevator car.

In an implementation form of the first aspect, performing an elevator associated action based on the classifying comprises postponing at least one waiting level call.

In an implementation form of the first aspect, the at least one radar sensor comprises a pulsed coherent radar, a Doppler radar, an impulse radar, a frequency modulated continuous wave, FMCW, radar, an ultra-wide-band, UWB, radar, and a radar with beam forming.

According to a second aspect, there is provided an apparatus comprising at least one processor and at least one memory storing instructions that, when executed by the at least one processor, cause the apparatus to at least perform: obtaining sensor data from at least one radar sensor arranged in an elevator car; analyzing the sensor data to provide micro-Doppler signatures of at least one moving object associated with the elevator car in a direction towards the at least one radar sensor and/or away from the at least one radar sensor; classifying the at least one moving object associated with the elevator car into at least one type based on their micro-Doppler signatures; and performing an elevator associated action based on the classifying.

In an implementation form of the second aspect, the at least one memory store instructions that, when executed by the at least one processor, cause the apparatus to at least perform: determining the number of passengers in the elevator car.

In an implementation form of the second aspect, the at least one memory store instructions that, when executed by the at least one processor, cause the apparatus to at least perform: detecting an entrapment situation in the elevator car, and triggering an alert in response to detecting the entrapment situation in the elevator car.

In an implementation form of the second aspect, the at least one memory store instructions that, when executed by the at least one processor, cause the apparatus to at least perform: determining the entrapment situation by detecting at least one person inside the elevator car and detecting that the elevator doors are closed.

In an implementation form of the second aspect, the at least one memory store instructions that, when executed by the at least one processor, cause the apparatus to at least perform: detecting a prohibited object in the elevator car, and stopping the elevator car in response to detecting the prohibited object in the elevator car.

In an implementation form of the second aspect, the at least one memory store instructions that, when executed by the at least one processor, cause the apparatus to at least perform: detecting at least one predetermined object entering the elevator car, and adjusting door closing times of the elevator in response to detecting the at least one predetermined object entering the elevator car.

In an implementation form of the second aspect, the at least one memory store instructions that, when executed by the at least one processor, cause the apparatus to at least perform: postponing at least one waiting level call.

In an implementation form of the second aspect, the at least one radar sensor comprises a pulsed coherent radar, a Doppler radar, an impulse radar, a frequency modulated continuous wave, FMCW, radar, an ultra-wide-band, UWB, radar, and a radar with beam forming.

According to a third aspect, there is provided a computer program comprising instructions which, when the program is executed by at least one processor, cause an apparatus to perform the method of the first aspect.

According to a fourth aspect, there is provided a computer-readable medium comprising a computer program comprising instructions which, when the program is executed by at least one processor, cause an apparatus to perform the method of the first aspect.

According to a fifth aspect, there is provided a system comprising an apparatus of the second aspect and at least one sensor arranged in an elevator car and configured to provide sensor data to the apparatus.

According to a sixth aspect, there is provided an apparatus comprising means for: obtaining sensor data from at least one radar sensor arranged in an elevator car; analyzing the sensor data to provide micro-Doppler signatures of at least one moving object associated with the elevator car in a direction towards the at least one radar sensor and/or away from the at least one radar sensor; classifying the at least one moving object associated with the elevator car into at least one type based on their micro-Doppler signatures; and performing an elevator associated action based on the classifying.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow diagram of a method according to an example embodiment.

FIG. 2 illustrates a system according to an example embodiment.

FIG. 3 illustrates a block diagram of an apparatus according to an example embodiment.

### DETAILED DESCRIPTION

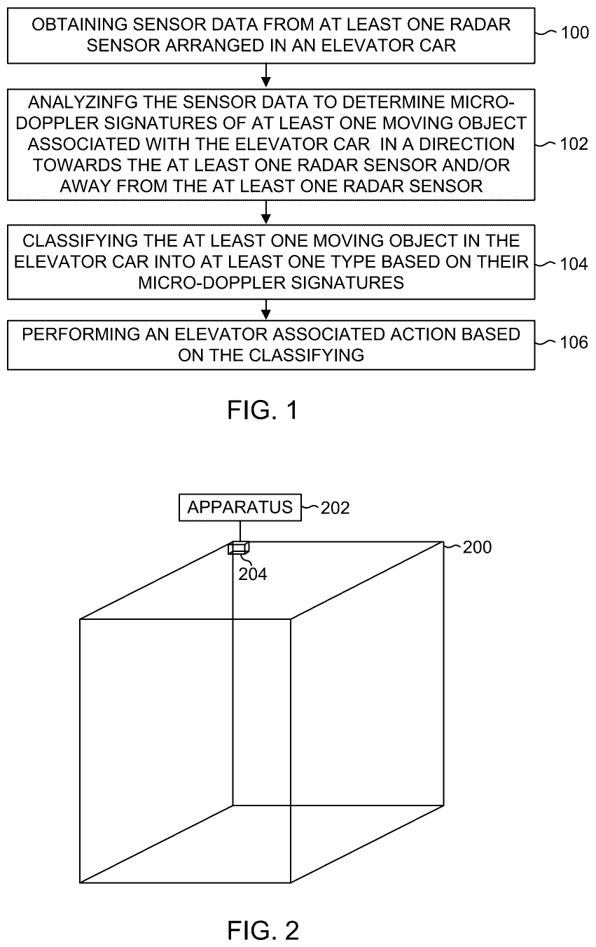

FIG. 1 illustrates a flow diagram of a method according to an example embodiment.

At 100, sensor data may be obtained from at least one radar sensor arranged in an elevator car. In an example embodiment, the at least one radar sensor comprises a pulsed coherent radar, a Doppler radar, an impulse radar, a frequency modulated continuous wave, FMCW, radar, an ultra-wide-band, UWB, radar, or a radar with beam forming.

At 102, the sensor data is analyzed to provide micro-Doppler signatures of at least one moving object associated with the elevator car in a direction towards the at least one radar sensor and/or away from the at least one radar sensor. The micro-Doppler signature is a distinctive characteristic of the observed micro-Doppler effect in an object. The signature may be used to refer to the characteristic expression of an object. When examining the micro-Doppler effect, the distinctive micro-Doppler characteristic, i.e., the micro-Doppler signature of an object, it may allow the recognition of an object's identity or type through its movement.

At 104, the at least one moving object associated with the elevator car may be classified into at least one type based on their micro-Doppler signatures. A type may comprise, for example, a walking passenger, an electric scooter, a wheelchair, a person sitting in a wheelchair, an animal, a bike, a hospital bed, a moving robot etc.

At 106, an elevator associated action may be performed or caused to be performed based on the classifying. In the elevator environment, people and other objects typically walk/move into the elevator car from one direction, i.e. via the elevator door. Thus, the direction of the movement is in practice towards or away from the radar sensor if the radar sensor is placed on the far end of the elevator car. Thus, it is sufficient that the sensor signal analysis is working for objects that move in one direction, i.e. towards or away from the radar sensor.

In an example embodiment, performing an elevator associated action based on the classifying may comprise detecting an entrapment situation in the elevator car, and triggering an alert in response to detecting the entrapment situation in the elevator car. As the micro-Doppler signatures may be used to determine entering and exiting passengers, this provides also information whether some passenger is present in the elevator car for a longer time period while the elevator doors are closed.

In an example embodiment, performing an elevator associated action based on the classifying may comprise determining the number of passengers in the elevator car may be determined based on the micro-Doppler signatures of the at least one moving object. The entrapment situation may be determined by detecting at least one person inside the elevator car and detecting that the elevator doors are closed. In other words, the micro-Doppler signatures may identify passengers entering the elevator car and exiting the elevator car, and this information may be used in determining the number of passengers in the elevator car.

In an example embodiment, performing an elevator associated action based on the classifying may comprise detecting a prohibited object in the elevator car, and stopping the elevator car in response to detecting the prohibited object in the elevator car. Micro-Doppler signatures may be beforehand classified, for example, to include a class or type of prohibited objects. As each object has its own characterizing micro-Doppler signature, it is possible to make the classification. The prohibited object may be, for example, an electronic scooter.

In an example embodiment, performing an elevator associated action based on the classifying may comprise detecting at least one predetermined object entering the elevator car, and adjusting door closing times of the elevator in response to detecting the least one predetermined object entering the elevator car. For example, a specific object, for example, a robot, a hospital bed, a wheelchair, large objects etc., may require longer elevator door times. As each object has its own characterizing micro-Doppler signature, it is possible to make the classification to identify the predetermined objects and thus enable setting longer door times for these objects. For example, robots are typically slower to move than humans and often stuck in between the closing elevator doors. Then a robot typically waits a while before trying to move again, and this time may be longer than the time at which the elevator doors are closes again. Thus, the robot may get stuck in the closing elevator doors until a human involvement. By adjusting the door closing times this drawback is overcome.

In an example embodiment, performing an elevator associated action based on the classifying may comprise postponing at least one waiting level call, for example, when the elevator car is full of almost full. For example, the number of incoming passengers to the elevator car may be counted and the waiting level calls may then be postponed if the elevator car is full or almost full. In another example embodiment, if the elevator car carries a hospital bed, the waiting level calls may then be postponed. Instead, the elevator car can be controlled to travel directly to the destination floor.

FIG. 2 illustrates a system according to an example embodiment. At least one sensor 204 may be arranged inside an elevator car 200 to sense the interior of the elevator car 200. The at least one sensor 204 may comprise, for example, a pulsed coherent radar, a Doppler radar, an impulse radar, a frequency modulated continuous wave (FMCW) radar, an ultra-wide-band (UWB) radar, and a radar with beam forming. The at least one sensor 204 is communicatively connected to an apparatus 202. The connection between the apparatus 202 and the at least one sensor 204 may be wired or wireless. The apparatus 202 may be configured to implement the method discussed in more detail in FIG. 1 and its description. In an example embodiment, the apparatus 202 may be an internal entity, for example, an elevator controller or some other entity of an elevator system. In another example embodiment, the apparatus 202 may be a cloud-based entity, for example, network a server communicatively connected to the at least one sensor 204.

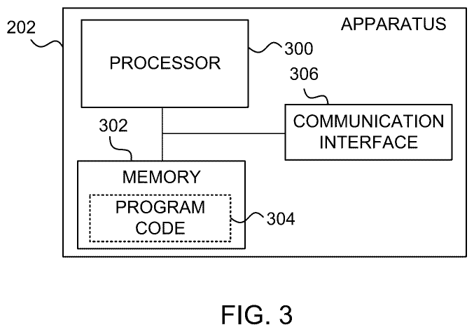

FIG. 3 illustrates a block diagram of an apparatus 202 according to an example embodiment. The apparatus 202 comprises one or more processors 300, and one or more memories 302 that comprise computer program code. The apparatus 202 may also include a communication interface 306 for wired and/or wireless communication. Although the apparatus 202 is depicted to include only one processor 300, the apparatus 202 may include more than one processor. In an example embodiment, the memory 302 is capable of storing instructions, such as an operating system and/or various applications.

Furthermore, the processor 300 is capable of executing the instructions stored in the memory 302. In an example embodiment, the processor 300 may be embodied as a multi-core processor, a single core processor, or a combination of one or more multi-core processors and one or more single core processors. For example, the processor 300 may be embodied as one or more of various such as processing devices, a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 300 may be configured to execute hard-coded functionality. In an example embodiment, the processor 300 is embodied as an executor of software instructions, wherein the instructions may specifically configure the processor 300 to perform the algorithms and/or operations described herein when the instructions are executed, for example, the steps discussed relating to FIG. 1.

The memory 302 may be embodied as one or more volatile memory devices, one or more non-volatile memory devices, and/or a combination of one or more volatile memory devices and non-volatile memory devices. For example, the memory 302 may be embodied as semiconductor memories (such as mask ROM, PROM (programmable ROM), EPROM (erasable PROM), flash ROM, RAM (random access memory), etc.).

In an embodiment, the at least one memory 302 may store program instructions 304 that, when executed by the at least one processor 300, cause the apparatus 202 to perform the functionality of the various embodiments discussed herein. Further, in an embodiment, at least one of the processor 300 and the memory 302 may constitute means for implementing the discussed functionality. Further, the apparatus 202 may be configured to obtain sensor data from at least one radar sensor arranged in an elevator car, analyze the sensor data to provide micro-Doppler signatures of at least one moving object associated with the elevator car a direction towards the at least one radar sensor and/or away from the at least one radar sensor, classify the at least one moving object associated with the elevator car into at least one type based on their micro-Doppler signatures, and perform an elevator associated action based on the classify.

At least one of the examples and embodiments disclosed above may enable a solution in which inexpensive and simple radar sensors may be used in providing the classification of at least one moving object in an elevator. Further, at least one of the examples and embodiments disclosed above may enable a solution in which privacy is preserved by using a radar-based solution. In other words, passengers or other objects are not identified like in camera based solutions. Further, at least one of the examples and embodiments disclosed above may enable a solution in which different actions may be performed based on the type of a moving object.

Example embodiments may be implemented in software, hardware, application logic or a combination of software, hardware and application logic. The example embodiments can store information relating to various methods described herein. This information can be stored in one or more memories, such as a hard disk, an optical disk, a solid-state drive (SSD), a magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The components of the example embodiments may include computer readable medium or memories for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method comprising:
obtaining sensor data from at least one radar sensor arranged in an elevator car;
analyzing the sensor data to provide micro-Doppler signatures of at least one moving object associated with the elevator car in a direction towards the at least one radar sensor and/or away from the at least one radar sensor;
classifying the at least one moving object associated with the elevator car into at least one type based on their micro-Doppler signatures; and
performing an elevator associated action based on the classifying.

2. The method according to claim 1, wherein performing an elevator associated action based on the classifying comprises:
detecting an entrapment situation in the elevator car; and
triggering an alert in response to detecting the entrapment situation in the elevator car.

3. The method according to claim 2, further comprising:
determining the entrapment situation by detecting at least one person inside the elevator car and detecting that the elevator doors are closed.

4. The method according to claim 1, wherein performing an elevator associated action based on the classifying comprises:
detecting a prohibited object in the elevator car; and
stopping the elevator car in response to detecting the prohibited object in the elevator car.

5. The method according to claim 1, wherein performing an elevator associated action based on the classifying comprises:
determining the number of passengers in the elevator car.

6. The method according to claim 1, wherein performing an elevator associated action based on the classifying comprises:
detecting at least one predetermined object entering the elevator car; and
adjusting door closing times of the elevator in response to detecting the least one predetermined object entering the elevator car.

7. The method according to claim 1, wherein performing an elevator associated action based on the classifying comprises:
postponing at least one waiting level call.

8. The method according to claim 1, wherein the at least one radar sensor comprises a pulsed coherent radar, a Doppler radar, an impulse radar, a frequency modulated continuous wave, FMCW, radar, an ultra-wide-band, UWB, radar, and a radar with beam forming.

9. An apparatus comprising:
at least one processor; and
at least one memory storing instructions that, when executed by the at least one processor, cause the apparatus to at least perform:
obtaining sensor data from at least one radar sensor arranged in an elevator car;
analyzing the sensor data to provide micro-Doppler signatures of at least one moving object associated with the elevator car in a direction towards the at least one radar sensor and/or away from the at least one radar sensor;
classifying the at least one moving object associated with the elevator car into at least one type based on their micro-Doppler signatures; and
performing an elevator associated action based on the classifying.

10. The apparatus according to claim 9, wherein the at least one memory store instructions that, when executed by the at least one processor, cause the apparatus to at least perform:
detecting an entrapment situation in the elevator car; and
triggering an alert in response to detecting the entrapment situation in the elevator car.

11. The apparatus according to claim 10, wherein the at least one memory store instructions that, when executed by the at least one processor, cause the apparatus to at least perform:
determining the entrapment situation by detecting at least one person inside the elevator car and detecting that the elevator doors are closed.

12. The apparatus according to claim 9, wherein the at least one memory store instructions that, when executed by the at least one processor, cause the apparatus to at least perform:
detecting a prohibited object in the elevator car; and
stopping the elevator car in response to detecting the prohibited object in the elevator car.

13. The apparatus according to claim 9, wherein the at least one memory store instructions that, when executed by the at least one processor, cause the apparatus to at least perform:
determining the number of passengers in the elevator car.

14. The apparatus according to claim 9, wherein the at least one memory store instructions that, when executed by the at least one processor, cause the apparatus to at least perform:
detecting at least one predetermined object entering the elevator car; and
adjusting door closing times of the elevator in response to detecting the at least one predetermined object entering the elevator car.

15. The apparatus according to claim 9, wherein the at least one memory store instructions that, when executed by the at least one processor, cause the apparatus to at least perform:
postponing at least one waiting level call.

16. The apparatus according to claim 8, wherein the at least one radar sensor comprises a pulsed coherent radar, a Doppler radar, an impulse radar, a frequency modulated continuous wave (FMCW) radar, an ultra-wide-band (UWB) radar, and a radar with beam forming.

17. A non-transitory computer readable medium comprising a computer program comprising instructions which, when the program is executed by at least one processor, cause an apparatus to perform the method of claim 1.

18. A non-transitory computer-readable medium comprising a computer program comprising instructions which, when the program is executed by at least one processor, cause an apparatus to perform the method of claim 2.

19. A system comprising:
an apparatus according to claim 9; and
at least one sensor arranged in an elevator car and configured to provide sensor data to the apparatus.

20. The method according to claim 2, wherein performing an elevator associated action based on the classifying comprises:
postponing at least one waiting level call.
